(19) United States
(12) Patent Application Publication
(10) Pub. No.: US 2024/0185232 A1
(43) Pub. Date: Jun. 6, 2024

(54) PAYMENT VEHICLE WITH ON AND OFF FUNCTION

(71) Applicant: Wells Fargo Bank, N.A., San Francisco, CA (US)

(72) Inventors: Michael T. Duke, Monroe, NC (US); Dean Patrick Nolan, Charlotte, NC (US)

(73) Assignee: Wells Fargo Bank, N.A., San Francisco, CA (US)

(21) Appl. No.: 18/439,500

(22) Filed: Feb. 12, 2024

Related U.S. Application Data
(63) Continuation of application No. 17/316,022, filed on May 10, 2021, now Pat. No. 11,900,390.
Application No. 17/316,022 is a continuation of application No. 16/825,019, filed on Mar. 20, 2020, now Pat. No. 11,010,766.
Application No. 16/825,019 is a continuation of application No. 15/792,581, filed on Oct. 24, 2017, now Pat. No. 10,755,282.
Application No. 15/792,581 is a continuation of application No. 13/826,246, filed on Mar. 14, 2013, now Pat. No. 10,410,217.
Application No. 13/826,246 is a division of application No. 12/316,996, filed on Dec. 18, 2008, now abandoned.
(60) Provisional application No. 61/197,872, filed on Oct. 31, 2008.

(51) Int. Cl. G06Q 20/38; G06Q 20/10; G06Q 20/40; G06Q 20/42; G06Q 40/00

(52) U.S. Cl. CPC G06Q 20/382; G06Q 20/105; G06Q 20/40; G06Q 20/405; G06Q 20/42; G06Q 40/00

(57) ABSTRACT

A computer-based network system and method for using a payment vehicle having an on and off function. The system comprises a payment vehicle comprising an on and off function to enable or to disable the payment vehicle in the computer-based network for processing an electronic payment transaction, a holder of the payment vehicle, and a computer payment network wherein the computer payment network comprises a transaction engine for enabling or for disabling the payment vehicle at a request of the holder of the payment vehicle.

### CROSS-REFERENCE TO RELATED PATENT APPLICATIONS

This application is a continuation of U.S. patent application Ser. No. 17/316,022 filed May 10, 2021, which is a continuation of U.S. patent application Ser. No. 16/825,019 filed Mar. 20, 2020, which is a continuation of U.S. patent application Ser. No. 15/792,581 filed Oct. 24, 2017, which is a continuation of U.S. patent application Ser. No. 13/826,246 filed Mar. 14, 2013, which is a divisional of U.S. patent application Ser. No. 12/316,996 filed Dec. 18, 2008, which claims priority to U.S. Provisional Application Ser. No. 61/197,872 filed Oct. 31, 2008, the disclosures of which are herein incorporated by reference in their entireties.

### BACKGROUND

The present application relates to a payment vehicle having an on and off function for use in a computer-based network for processing electronic payment transactions.

In today's payment environment, there are a very few number of payment transactions or other financial transactions that occur with cash. Most purchases occur with forms of payment other than cash using various payment instruments such as credit cards, debit cards, among others. Furthermore, there are an increasing number of payment transactions that occur electronically or via a web interface such as over the internet or worldwide web. With an increasing volume of transactions conducted with payment instruments other than cash and often not by the purchaser in person at point of sale, there is an increased likelihood of fraudulent transactions and lack of personal control over the payment transaction.

Additionally, in today's payment environment, a payment instrument is always turned “on” leading to abuse and fraud. Currently, a payment vehicle can be blocked if a credit or debit card, for example, is lost or stolen by calling a customer service representative of the card issuer after occurrence of the fraudulent event and requesting that the card be canceled or blocked after the occurrence. There are numerous disadvantages associated with such a process. For example, there may be a delay before a payment instrument holder even recognizes that a fraudulent event occurred or is occurring using the payment holder's payment instrument. There is also a real-time delay between when a payment instrument holder recognizes that there has been fraud or abuse associated with its payment instrument and when the customer service representative is able to cancel or block the account. Fraudulent use of a card can even occur while the customer service representative is canceling or blocking the account associated with the payment vehicle. Thus, a payment holder does not have direct control and is limited by currently existing processes. Likewise, a payment instrument holder who desires to make changes to its account does not have direct control to do so and also customarily relies upon a customer service representative.

With respect to misuse or fraudulent use of a payment instrument, there are ways in today's existing payment systems to minimize fraud and abuse of the payment vehicle; however, they require assistance outside of the control of the payment vehicle holder. For example, a credit or debit card account can be closed, a temporary block can be placed on the card, or a country level block can be placed (for example, do not accept any charges being made in a specified country). Unfortunately, such controls are implemented after occurrence of the event.

Thus, there is a need to minimize the current risk to a holder of a payment instrument. There is also a need to find a way to shift control of the payment instrument to the payment instrument holder as well as to mitigate abuse and fraud associated with unauthorized use of a payment vehicle and the delays associated with mitigating such loss. There is also a need to have greater control in the payment process.

As indicated above, most payment transactions today involve the transfer of electronic funds. For purposes of background, the current industry practice with respect to electronic funds payment using a payment instrument is best shown by referring now to FIG. 1 which is a flow diagram illustrating a known process for purchaser payment. According to FIG. 1, a purchaser typically carries multiple forms of payment to allow the purchaser to choose which source of funding to use to pay for a given purchase. As is the current practice in the industry, a line of communication must be made between each form of payment used by a purchaser and each source of funds via an existing computer payment network or system. This occurs for each transaction. Thus, each transaction may require a different form of payment, a different point of sale (POS) terminal, a different computer payment system, a different source of funds, or a combination thereof. Thus, for multiple transactions, there are numerous communications and many transaction processing steps that must occur.

FIG. 2A is a flow diagram which expands upon the existing computer payment system infrastructure of FIG. 1 and is an example of a credit or debit route for a VISA or MasterCard transaction. The parties to an authorization and a settlement VISA or MasterCard transaction typically comprise a purchaser, a merchant, an optional International Sales Organization (ISO), a merchant acquirer, VISA/MasterCard, an optional issuer processor, an issuer, and a source of funds. A series of events shown in FIG. 2A has to occur for each VISA/MasterCard transaction using a VISA/MasterCard payment card used at a merchant point of sale (POS) terminal. Among the disadvantages associated with such a system is that it requires purchasers to carry multiple payment instruments that are always “on,” increases the risk that a payment instrument such as a credit card or a debit card will get lost or stolen which in turn increases the risk of fraud, and does not provide the payment instrument holder the ability to control the terms and conditions of the use of the payment instrument at point of sale.

FIG. 2B is a flow diagram illustrating the current industry process for authorization of a VISA/MasterCard transaction. FIG. 2C is a flow diagram illustrating the current industry process for settlement of a VISA/MasterCard transaction. In the authorization process, as shown in FIG. 2B, a purchaser uses a VISA/MasterCard payment card to pay for goods or services at a merchant point of sale (POS) terminal, the transaction is captured by an ISO or a merchant acquirer. An ISO is an independent sales organization that is a reseller of acquirer services. A merchant acquirer is typically a bank member of a card network that collects payments on behalf of a merchant. The transaction is then routed by the merchant acquirer to the computer payment network which, in this example, is VISA or MasterCard. The transaction is then routed to an issuer. The issuer is typically a bank member of a card network that issues network approved cards. The issuer may approve or deny a transaction based upon the presence of fraudulent activity or upon funds availability. The funds availability is communicatively connected to a source of funds as shown in FIG. 2A. The transaction is either approved or declined and returned to the merchant POS terminal.

With respect to the process for settlement shown m FIG. 2C, VISA/MasterCard facilitates settlement between the merchant acquirer and issuer. The merchant acquirer then settles with the merchant. The issuer then settles with the purchaser using the funding source that is linked to the VISA MasterCard payment card.

The above process is known and currently occurs for each such payment transaction. As indicated above, there is no means for a payment holder to have direct control over the payment instrument's availability for use because it is always “on.” There is no means to address fraudulent use until after the occurrence of the fraud or misuse. Thus, there remains a need for an alternative payment instrument that addresses these enumerated concerns as well as others of the payment instrument holder.

### SUMMARY

The present disclosure is directed to a computer-based network system and method for using a payment vehicle having an on and off function. The system comprises a payment vehicle comprising an on and off function to enable or to disable the payment vehicle in the computer-based network for processing an electronic payment transaction. The system also comprises a holder of the payment vehicle and a computer payment network. The computer payment network preferably comprises a transaction engine for enabling or for disabling the payment vehicle at a request of the holder of the payment vehicle.

The present disclosure also provides for a method of using the payment vehicle having an on and off function. The method generally comprises receiving a message from a payment vehicle holder to enable a payment vehicle of the payment vehicle holder prior to a payment transaction and enabling the payment vehicle by removing a block placed on the payment vehicle. Alternatively, the method generally comprises receiving a message from a payment vehicle holder to disable a payment vehicle of the payment vehicle holder and disabling the payment vehicle by placing a block on the payment vehicle.

The method of using a payment vehicle having an on and off function also generally comprises receiving a request from a user to use a payment vehicle of a payment vehicle holder for an electronic payment transaction in a computer-based payment network prior to a payment transaction, checking to see if a block has been placed or removed by the payment vehicle holder on the payment vehicle, and terminating the electronic payment transaction if the block has been placed on the payment vehicle.

There are also numerous features and functions associated with the payment vehicle having an on and off function in accordance with the present invention. Many of which are described in detail herein. Further areas of applicability of the present invention will become apparent from the detailed description provided hereinafter. It should be understood that th˜ detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a flow diagram illustrating a known process for making purchaser payments with a traditional payment instrument and computer network payment system.

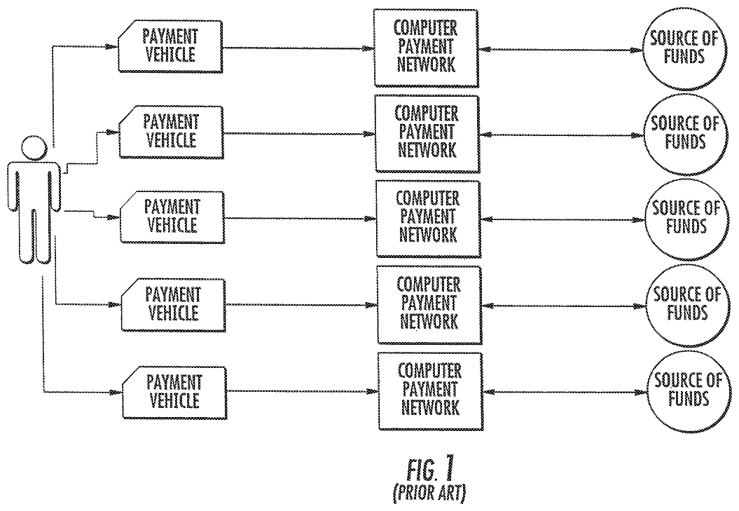

FIG. 2A is a flow diagram which expands upon the existing computer payment system infrastructure of FIG. 1 and is an example of a credit or debit route for a typical VISA or MasterCard transaction.

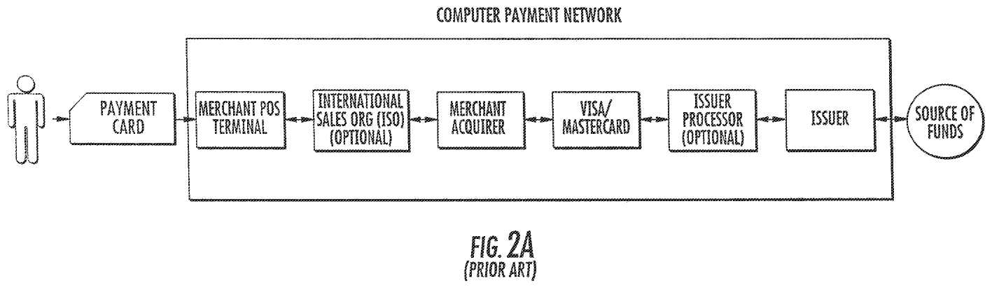

FIG. 2B is a flow diagram of the current industry process for authorization of a VISA/MasterCard transaction using a traditional payment card and computer network payment system.

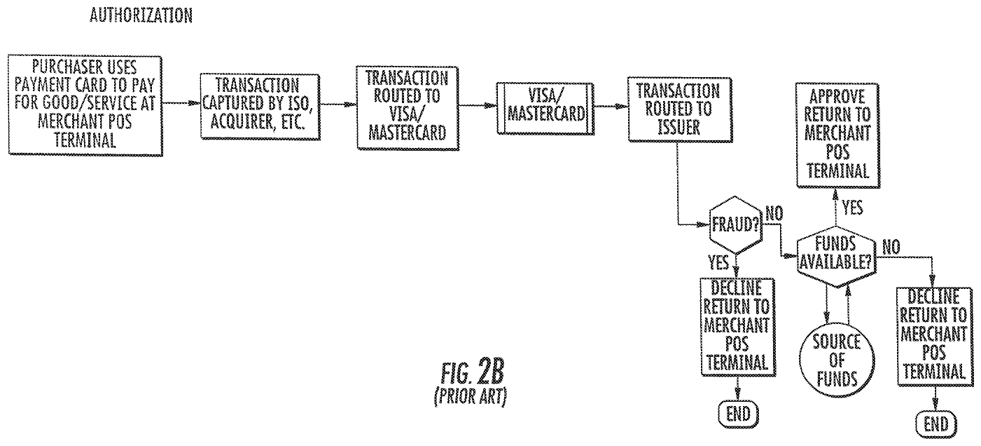

FIG. 2C is a flow diagram of the current industry process for settlement of a VISA/MasterCard transaction.

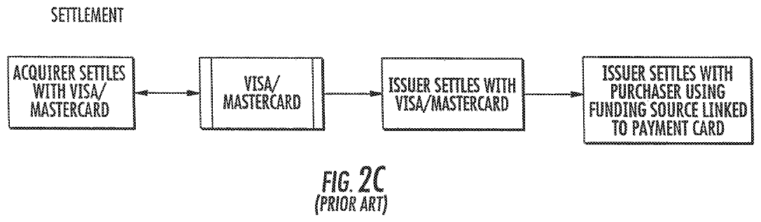

FIG. 3 is a flow diagram of the overall system and method of the present invention.

FIG. 4A is a flow diagram of the authorization process for a payment transaction using a payment vehicle having the on and off feature of the present invention.

FIG. 4B is a flow diagram illustrating the overall environment in which the computer-based payment system and payment vehicle of the present invention operates.

FIG. 4C is a flow diagram illustrating the settlement process for a payment transaction using a payment vehicle having the on and off feature of the present invention.

### DETAILED DESCRIPTION

The following detailed description of the embodiment(s) is merely exemplary in nature and is in no way intended to limit the invention, its application, or uses.

The present disclosure relates to a payment vehicle having an “on” and “off” function. The “on” and “off” feature of the payment vehicle of the present invention permits the holder of a payment vehicle to provide instructions as to whether to turn its payment vehicle “on” when it is ready to be used and to be turned “off” to prevent use when the holder of the payment vehicle so chooses. The use to be prevented may either be of the payment vehicle holder itself or to prevent unauthorized use by another.

The present disclosure provides a way in which a holder of a payment vehicle, preferably a customer of the card issuer, can exert leverage or control over its payment vehicle.

A payment vehicle, as referred to herein, refers to an instrument used to conduct a payment transaction excluding cash. Examples of payment vehicles suitable for use in the present invention include, but are not limited to, a debit card, credit card, pre-paid card, stored value card, automated teller machine (ATM), wire, automated clearinghouse (ACH), online banking, online bill pay, and internet payment account. The payment vehicle of the present invention may be extended to other online payment services or instruments.

For example, a payment vehicle holder can use a device such as a personal data assistant (PDA) or a cell phone to send a text message that reads “card on” or to send a text message that reads “card off” to the bank or other institution that issued the payment vehicle to the cardholder.

The payment vehicle holder can keep the payment vehicle “off” and then send a text message to the payment vehicle issuer to turn it “on” for any number of reasons or at any time the holder of the payment vehicle so chooses. Likewise, a text message can be sent to turn it back “off” when done. There are any number of methods that are able to be used to notify to turn the payment vehicle “on” and “off” within the scope of the present invention. A text message is just one non-limiting example. The payment vehicle holder can establish or set rules with the card issuer as to when the card is to be turned “on” or “off.” The holder of the payment vehicle can check card status at any time. The payment vehicle can be set to have time-based access. For example, rules may be set by time period such as the payment vehicle holder instructs to turn the payment vehicle off from 11 pm to 8 am daily. Another example is that the payment vehicle can be turned on or off based upon a specified transaction type such as by a merchant category code. Still yet another example is that the payment vehicle holder could determine that the payment vehicle only is “on” for gas and grocery purchases but “off” for internet purchases, international purchases, among others. Any number of rules could be set alone or in combination. Another example is that the payment vehicle can be turned on or off based upon country code.

In addition, the present disclosure relates to a payment vehicle having the “on” and “off” feature such as where the payment vehicle is an online banking account having established rules for when access is turned on and off. For example, the holder of the online banking account could set a rule that there can be no payments made using the online banking account, for example, between 11 pm and 8 am daily. Alternatively, the online banking account can be set such that fund status can be viewed but funds cannot be moved or transferred.

The “on” and “off” feature could be utilized in an authorization environment or in an environment where authorizations are not utilized. An important aspect to the present invention is the “on” and “off” functionality and the ability to give a payment vehicle holder who is typically a customer of a financial institution control of the payment vehicle in a computer-based network system leveraging that functionality.

The logic which is the basis for the “on” and “off” functionality in the computer-based network system is comprised within the payment vehicle's processing environment. The following non-limiting example relates to the processing of credit cards and debit cards although the logic is readily applied to other types of payment vehicles.

As mentioned previously, a typical credit card transaction involves a two-part transaction, namely authorization and settlement. During authorization, the question is asked if the money or funds are there and the question is asked if the card is valid. It can be a signature-based transaction or a PIN-based transaction. A pin-based transaction is a transaction in which authorization and settlement occur at same time. The method of authorization is card specific and is known in the industry. For example, VISA has a different payment network than other card providers. With the payment vehicle having the “on” and “off” feature of the present invention, the merchant would know that an invalid card is turned “off” for purposes of the transaction.

Settlement processing occurs with purchases made by internet, mail order, phone order, or card on file. Some of these go through an authorization transaction coming in looking for settlement from a merchant. A payment vehicle having the “on” and “off” feature of the present invention could be used in these transactions as well as other transactions that may involve interlink, automated teller machine (ATM), ACH, wires and others.

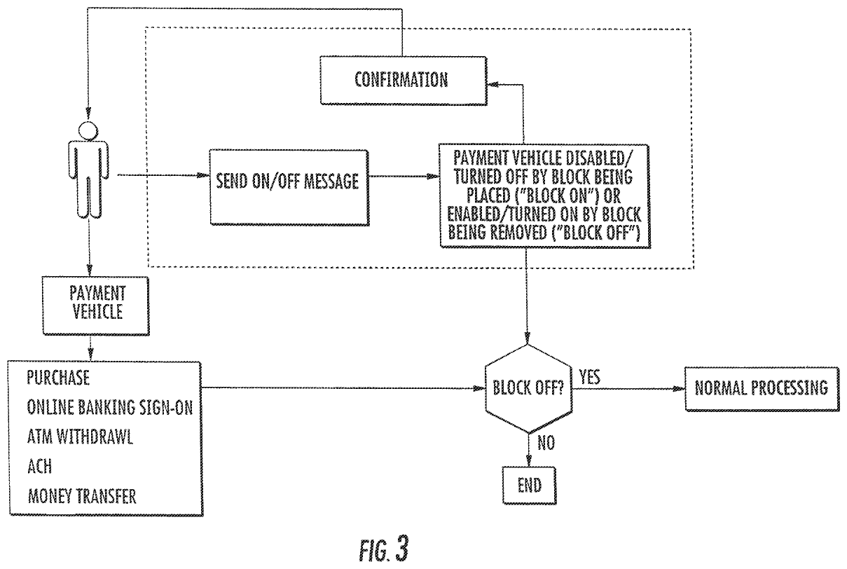

Referring now to the figures, FIG. 3 is a flow diagram illustrating the overall system and method of the present disclosure. As shown in FIG. 3, a payment vehicle holder sends an “on” or “off” message regarding its payment vehicle. After receipt of the message, the payment vehicle is either disabled (i.e. turned off) by a block being placed or enabled (i.e. turned on) by a block being removed. A confirmation of whether the block is on or off is electronically sent to the payment vehicle holder. The payment vehicle holder uses its payment vehicle to for example, make a purchase, sign on to online banking, make an ATM withdrawal, make an ACH deposit, or money transfer. It is checked to see if the block is off for the payment vehicle. If the block is not off, the transaction ends. If the block is off, the transaction proceeds through normal processing for that respective payment vehicle.

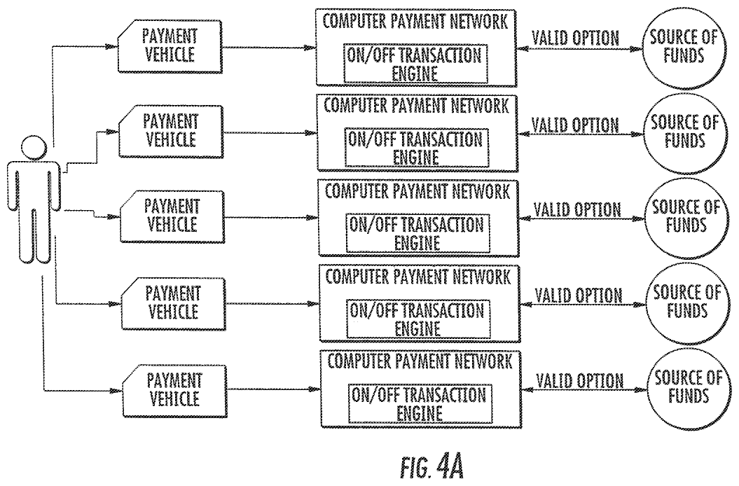

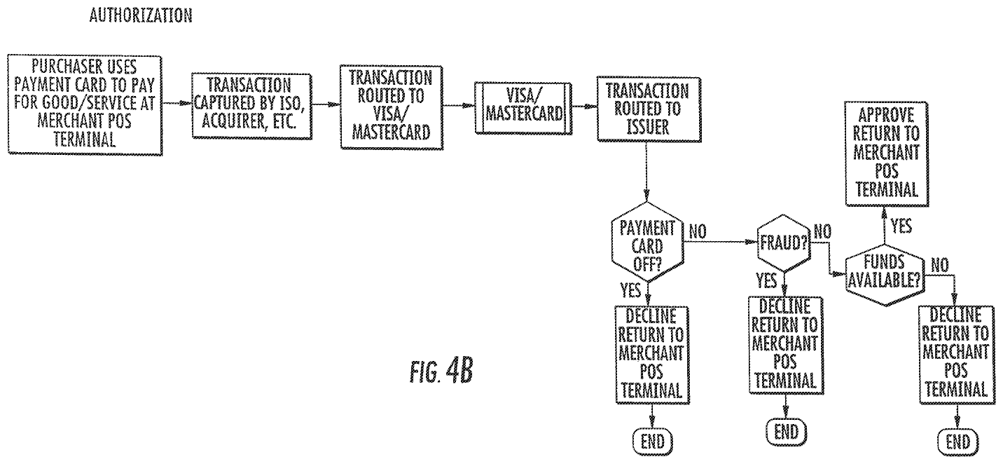

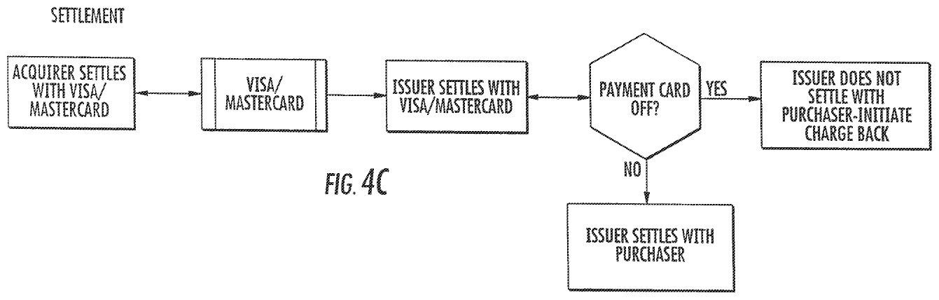

FIG. 4A illustrates a payment vehicle having an “on” and “off” feature in accordance with the present disclosure for use in a computer-based environment for processing electronic payment transactions. As shown in FIG. 4A, the system comprises a user, a payment vehicle, a computer payment network comprising an “on” and “off” transaction engine, and a source of funds. Preferably, the user is the holder of the payment vehicle; however, it is within the scope of the present invention that someone other than the payment vehicle holder would use the payment vehicle to make a purchase or to access funds. The “on” and “off” transaction engine further comprises the “on” and “off” logic to determine whether or not the payment vehicle is enabled or disabled (i.e. “on” or “off”) prior to a payment transaction. If the payment vehicle is “on” and a transaction is enabled (i.e. not disabled or blocked), it is a valid option and the computer payment network is connected to the source of funds. Each user potentially has access to multiple payment vehicles having this “on” and “off” functionality.

FIG. 4B is a flow diagram of the authorization process for a payment transaction using a payment vehicle having the “on” and “off” feature of the present disclosure. As shown in FIG. 4B, a purchaser uses a payment card to pay for goods and services at a merchant point of sale terminal. The transaction is captured by the ISO or merchant acquirer. The transaction is routed to VISA/Mastercard. From VISA/Mastercard, the transaction is routed to the issuer. The “on” and “off” transaction engine of the computer payment network queries whether the payment card is “off.” If it is “off,” the transaction is declined and returned to merchant point of sale terminal. If the payment card is not “off,” it is further processed to determine if there is fraud associated with the transaction. If there is fraud, the transaction is declined and returned to merchant point of sale terminal. If there is no fraud, the computer payment network checks to see if funds are available.

FIG. 4C is a flow diagram illustrating the settlement process for a payment transaction using a payment vehicle having the “on” and “off” feature of the present disclosure. As shown in FIG. 4C, the merchant acquirer settles with VISA/Mastercard. From VISA/Mastercard, the issuer settles with VISA/Mastercard. The “on” “on”/off” transaction engine queries whether the payment card is “off.” If the payment card is not “off,” the issuer settles with the purchaser. If the payment card is “off,” the issuer does not settle with the purchaser and initiates charge back to the card. If funds are available, the transaction is approved and returned to merchant point of sale terminal. If funds are not available, the transaction is declined and returned to merchant point of sale terminal.

As discussed herein, a payment vehicle having the “on” and “off” feature of the present invention allows the holder of the payment vehicle to remotely enable or disable its payment vehicle. The present invention provides a payment vehicle holder such as a customer of a financial institution control over its payment vehicle through leveraging of the “on” and “off” logic that may be transmitted, for example, via text message, e-mail, or other electronic means. While the present invention may be run in a variety of settings, it is advantageous for its logic to be run in a card processing environment.

There are numerous other features that are optionally associated with a payment vehicle having the “on” and “off” feature of the present invention. For example, a payment vehicle holder such as a customer of a financial institution is able to get the latest status of his or her payment vehicle. For example, the status may be enabled or disabled as well as more detailed reporting. This core functionality leads to additional features as described below.

Among the features of the present disclosure include time based access to the payment vehicles. For example, the payment vehicle is enabled from x time to y time. This may also be used for online banking access also.

A two credit/debit level authorization per transaction is another feature. For example, a customer will receive a communication, including but not limited to, a short message service (sms), a phone recording, or email verifying that it is permissible to allow the transaction.

Another feature of the payment vehicle of the present disclosure provides for the holder of the payment vehicle to refuse or stop a transaction that exceeds a predefined amount. The user may also refuse or stop a transaction of a specific type or limit the use of the payment vehicle to transactions of a certain type or merchant category code.

Yet another feature of the payment vehicle of the present disclosure is confirmation messaging. The payment vehicle holder receives a communication, including but not limited to, a sms, a phone recording, or email verifying that the payment vehicle holder's request to turn the payment vehicle on or off has been accomplished.

Still yet another feature of the payment vehicle of the present disclosure is vendor messaging. For example, when a person attempts to use a payment vehicle that has been turned off, the vendor receives a message informing him or her that the card is rejected as it is turned off.

It is within the scope of the present disclosure that this “on” and “off” feature associated with a payment vehicle is applicable to both existing and new customers, for example, of an institution such as a financial institution that is a card issuer. A customer enrolls for such a program and his/her account is marked accordingly. A customer selects a card account and agrees to use a card having the “on” and “off” feature. A customer then receives notification of enrollment, instructions, and initial card status. Such functionality is comprised, for example, in a card on/off transaction engine.

Thus, the payment vehicle of the present invention is advantageous for many reasons including because it provides additional security for payment vehicles. The payment vehicle of the present disclosure having the “on” and “off” feature permits customers to easily manage the security of their payment vehicles by switching them off when not in use. With the present invention, it is possible to disable the payment vehicle, such as a credit card, for safety or other purposes whenever the holder of a payment vehicle so chooses. For example, messaging is accomplished by sms or email.

Another advantage of the payment vehicle and method of the present disclosure is that it enhances loyalty through appreciation for the additional security, flexibility, and control that it provides consumers over their payment vehicles.

It will therefore be readily understood by those persons skilled in the art that the present in disclosure vention is susceptible of broad utility and application. Many embodiments and adaptations of the present disclosure other than those herein described, as well as many variations, modifications and equivalent arrangements, will be apparent from or reasonably suggested by the present invention and the foregoing description thereof, without departing from the substance or scope of the present disclosure. Accordingly, while the present disclosure has been described herein in detail in relation to its preferred embodiment, it is to be understood that this disclosure is only illustrative and exemplary of the present invention and is made merely for purposes of providing a full and enabling disclosure of the disclosure. The foregoing disclosure is not intended or to be construed to limit the present disclosure or otherwise to exclude any such other embodiments, adaptations, variations, modifications and equivalent arrangements.

What is claimed is:

1. A computing system comprising a transaction engine of a payment card network, the computing system configured to:
receive, from a user device of a user, a transmission including a rule to be applied to a payment vehicle of the user to limit which future transaction authorization requests are authorized by the computing system, the rule indicating whether to enable or disable the payment vehicle;
in response to receiving the transmission with the rule, update, by the transaction engine, logic of the payment card network associated with the payment vehicle to incorporate the rule, such that an updatable payment vehicle activation status of the logic is updated according to the rule to indicate whether the payment vehicle is enabled or disabled for transactions using the payment vehicle, the updated logic establishing additional security for the payment vehicle by automatically disabling the payment vehicle in response to transactions failing to satisfy the rule;
receive, from a merchant computing system of a merchant, a transaction authorization request;
apply, by the transaction engine, the updated logic to the transaction authorization request to determine that the transaction authorization request is for a transaction that does not satisfy the rule; and
in response to the transaction engine determining that the transaction does not satisfy the rule, automatically cause the transaction to be denied.

2. The computing system of claim 1, wherein the computing system is configured to receive an e-mail as the transmission with the rule.

3. The computing system of claim 1, wherein the computing system is configured to receive an electronic text message as the transmission with the rule.

4. The computing system of claim 1, wherein the computing system is further configured to:
receive, from the user device, a request for information regarding the logic associated with the payment vehicle; and
in response to receiving the request, provide information regarding the logic associated with the payment vehicle to the user device.

5. The computing system of claim 1, wherein the rule in the transmission indicates the user wishes to disable the payment vehicle, and wherein the computing system is configured to update, in response to receiving the transmission with the rule, the logic associated with the payment vehicle such that the payment vehicle is disabled for subsequent transactions.

6. The computing system of claim 1, wherein the rule in the transmission indicates the user wishes to disable the payment vehicle for transactions above an amount, and wherein the computing system is configured to update, in response to receiving the transmission with the rule, the logic associated with the payment vehicle such that subsequent transactions above the amount are not authorized by the computing system.

7. The computing system of claim 1, wherein the rule in the transmission indicates the user wishes to disable the payment vehicle for transactions at a set of merchants, and wherein the computing system is configured to update, in response to receiving the transmission with the rule, the logic associated with the payment vehicle such that subsequent transactions at the set of merchants are not authorized by the computing system.

8. The computing system of claim 1, wherein the rule in the transmission indicates the user wishes to disable the payment vehicle for transactions within a specified time interval, and wherein the computing system is configured to update, in response to receiving the transmission with the rule, the logic associated with the payment vehicle such that subsequent transactions within the specified time interval are not authorized by the computing system.

9. The computing system of claim 1, wherein the computing system is further configured to, in response to updating the logic associated with the payment vehicle, provide the user with confirmation of updating the logic.

10. The computing system of claim 1, wherein the computing system is further configured to:
receive, from a second merchant computing system of a second merchant, a second transaction authorization request;
apply the logic to the second transaction authorization request to determine that the second transaction authorization request is for a second transaction permitted by the rule; and
in response to the determining that the second transaction is permitted by the rule, transmit to at least one of the second merchant computing system and the user device a second indication that the second transaction is authorized.

11. The computing system of claim 1, wherein the computing system is further configured to:
in response to the transaction engine determining that the transaction does not satisfy the rule, transmit to at least one of the merchant computing system or the user device an indication that the transaction authorization request from the merchant is not authorized.

12. A computer-implemented method, comprising:
receiving, by a computing system, from a user device of a user, a transmission including a rule to be applied to a payment vehicle of the user to limit which future transaction authorization requests are authorized by the computing system, the rule indicating whether to enable or disable the payment vehicle;
in response to receiving the transmission with the rule, updating, by a transaction engine of the computing system, logic of a payment card network associated with the payment vehicle to incorporate the rule, such that an updatable payment vehicle activation status of the logic is updated according to the rule to indicate whether the payment vehicle is enabled or disabled for transactions using the payment vehicle, the updated logic establishing additional security for the payment vehicle by automatically disabling the payment vehicle in response to transactions failing to satisfy the rule;
receiving, by the computing system, from a merchant computing system of a merchant, a transaction authorization request;
applying the updated logic to the transaction authorization request to determine, by the transaction engine of the computing system, that the transaction authorization request is for a transaction that does not satisfy the rule;
in response to the transaction engine determining that the transaction does not satisfy the rule, transmit to at least one of the merchant computing system and the user device an indication that the transaction authorization request from the merchant is not authorized; and
in response to the transaction engine determining that the transaction does not satisfy the rule, automatically cause the transaction to be denied.

13. The computer-implemented method of claim 12, wherein the transmission comprises an electronic text message.

14. The computer-implemented method of claim 12, further comprising:
receiving, by the computing system, from the user device, a request for information regarding the logic associated with the payment vehicle; and
in response to receiving the request, providing, by the computing system, to the user device, information regarding the logic associated with the payment vehicle.

15. The computer-implemented method of claim 12, wherein the rule associated with the payment vehicle places the payment vehicle into a disabled state.

16. The computer-implemented method of claim 12, wherein the rule associated with the payment vehicle disables the payment vehicle for transactions above an amount.

17. The computer-implemented method of claim 12, wherein the rule associated with the payment vehicle disables the payment vehicle for transactions at a set of merchants.

18. The computer-implemented method of claim 12, wherein the rule associated with the payment vehicle disables the payment vehicle for transactions occurring within a specified time interval.

19. The computer-implemented method of claim 12, further comprising, in response to updating the logic associated with the payment vehicle, providing, by the computing system, the user with confirmation of updating the logic.

20. The computer-implemented method of claim 12, further comprising:
receiving, by the computing system, from a second merchant computing system of a second merchant, a second transaction authorization request;
applying the logic to the second transaction authorization request to determine, by the computing system, that the second transaction authorization request is for a second transaction permitted by the rule; and
in response to the determining that the second transaction is permitted by the rule, transmitting to at least one of the second merchant computing system and the user device, by the computing system, a second indication that the second transaction is authorized.
